(19) United States
(12) Patent Application Publication
(10) Pub. No.: US 2011/0193015 A1
(43) Pub. Date: Aug. 11, 2011

(54) PROCESS FOR PRODUCING LITHIUM IRON SULFIDE, AND PROCESS FOR PRODUCING LITHIUM TRANSITION METAL SULFIDE

(75) Inventors: Masahiro Yamamoto, Tokyo (JP); Yutaka Kinose, Tokyo (JP)

(73) Assignee: NIPPON CHEMICAL INDUSTRIAL CO., LTD., Tokyo (JP)

(21) Appl. No.: 13/125,164

(22) PCT Filed: Oct. 20, 2009
(86) PCT No.: PCT/JP2009/068061

§ 371 Date: Apr. 20, 2011

(30) Foreign Application Priority Data
Oct. 23, 2008 (JP) 2008-272807

(51) Int. Cl. H01M 4/58; C01B 17/20

(52) U.S. Cl. 252/182.1; 423/511

(57) ABSTRACT

A process for producing lithium iron sulfide, which is characterized by comprising: a first step of mixing an iron sulfide (a) with sulfur to produce a mixture of the iron sulfide (a) and sulfur, and subsequently burning the mixture of the iron sulfide (a) and sulfur in an inert gas atmosphere to produce an iron sulfide (b) that has an almost single phase as determined by an X-ray diffraction analysis and has a molar ratio of the content of element iron to the content of element sulfur (i.e., an Fe/S ratio) of not less than 0.90 and less than 1.00; and a second step of mixing the iron sulfide (b) with lithium sulfide to produce a mixture of the iron sulfide (b) and lithium sulfide, and subsequently burning the mixture of the iron sulfide (b) and lithium sulfide in an inert gas atmosphere to produce lithium iron sulfide represented by formula Li₂FeS₂.

### TECHNICAL FIELD

The present invention relates to a process for producing lithium iron sulfide and lithium transition metal sulfide which are used as positive electrode active materials of lithium ion secondary batteries.

### BACKGROUND ART

Lithium ion secondary batteries are widely used as power supplies of cellular phones or notebook computers. As a positive electrode active material of lithium ion secondary batteries, oxide-based or sulfide-based materials are known. Oxide-based materials are typically LiCoO₂, LiMnO₂, LiNiO₂, or the like, and are currently used in a wide range. On the other hand, sulfide-based materials include LiTiS₂, LiMoS₂, LiNbS₂, Li FeS₂, or the like. Since high-capacity secondary batteries can be produced from sulfide-based materials, studies are being made on sulfide-based materials as an alternative material of oxide-based materials.

Among sulfide-based materials, lithium iron sulfide (Li₂FeS₂) is an attractive material even from the standpoint of cost since a large amount of ferrous sulfide (FeS), which is a raw material for producing lithium iron sulfide, is present as a natural ore.

Because of the above facts, several studies are being made regarding processes for producing lithium iron sulfide (Li₂FeS₂). For example, Patent Citation 1 discloses a process in which iron sulfide and lithium sulfide are mixed, and the mixture is filled in a quartz tube and combusted in an argon gas stream. Patent Citation 2 discloses a process in which lithium sulfide and iron sulfide are made to react in a molten salt of halogenated lithium under an argon atmosphere. Patent Citation 3 discloses that iron sulfide is made to react with lithium sulfide in a solvent including molten sulfur. Non Patent Citation 1 discloses a process in which a mixture is placed in a crucible, and, furthermore, the crucible is placed in a quartz tube, which is sealed and combusted. In addition to the above, lithium iron sulfide and processes for producing lithium iron sulfide are also disclosed (Patent Citations 4 to 6, Non Patent Citation 1).

[Patent Citation 1] Japanese Unexamined Patent Application Publication No. 10-208782

[Patent Citation 2] U.S. Pat. No. 7,018,603

[Patent Citation 3] PCT Japanese Translation Patent Publication No. 2003-502265

[Patent Citation 4] Japanese Unexamined Patent Application Publication No. 2003-22808

[Patent Citation 5] Japanese Unexamined Patent Application Publication No. 2005-228586

[Patent Citation 6] Japanese Unexamined Patent Application Publication No. 2006-32232

[Non Patent Citation 1] Pages A1085 to A1090, No. 10, Vol. 148, Journal of Electrochemical Society (2001)

### DISCLOSURE OF INVENTION

### Technical Problem

However, according to the results of studies by the inventors of the invention, it was found that, if XRD analysis (hereinafter referred to also as XRD analysis) is performed on a product produced by the above process, heterophase peaks of lithium iron sulfide, such as Li₃FeS₂, Li₄FeS₂, Li₃Fe₂S₄, Li_{2.33}Fe_{0.67}S₂ or the like, in addition to lithium iron sulfide (Li₂FeS₂) are observed. Furthermore, it was also found that, other than lithium iron sulfide, peaks of metallic Fe, FeO, Fe₂O₃, which are oxides, Li₂S of the raw material, or the like are observed. In summary, in the processes of the related art, there is a problem in that it is difficult to produce single phase lithium iron sulfide (Li₂FeS₂).

In addition, even with regard to lithium transition metal sulfide other than lithium iron sulfide (Li₂FeS₂), similarly, there is a problem in that it is difficult to produce single phase lithium transition metal sulfide.

Therefore, the object of the invention is to provide a process for producing single phase lithium iron sulfide (Li₂FeS₂) as determined by XRD analysis. In addition, the object of the invention is to provide a process for producing single phase lithium transition metal sulfide as determined by XRD analysis.

### Technical Solution

As a result of thorough studies repeated in consideration of the above circumstances, the inventors of the invention found that (1) it is possible to produce iron sulfide having almost a single phase and a molar ratio of the compositional ratio of Fe/S of less than 1 by mixing and combusting iron sulfide and sulfur, (2) it is possible to produce single phase lithium iron sulfide (Li₂FeS₂) as determined by XRD analysis by reacting iron sulfide which is produced in the above manner and has a molar ratio of Fe/S in a specific range with lithium sulfide, or the like, and completed the invention.

That is, the invention (1) is to provide a process for producing lithium iron sulfide, including a first step of mixing an iron sulfide (a) with sulfur to produce a mixture of the iron sulfide (a) and sulfur, and subsequently combusting the mixture of the iron sulfide (a) and sulfur in an inert gas atmosphere to produce an iron sulfide (b) that has almost a single phase as determined by XRD analysis and has a molar ratio of the compositional ratio of the element iron to the element sulfur (Fe/S) of not less than 0.90 and less than 1.00; and a second step of mixing the iron sulfide (b) with lithium sulfide to produce a mixture of the iron sulfide (b) and lithium sulfide, and subsequently combusting the mixture of the iron sulfide (b) and lithium sulfide in an inert gas atmosphere to produce lithium iron sulfide represented by the formula Li₂FeS₂.

In addition, the invention (2) is to provide a process for producing lithium transition metal sulfide, including a first step of mixing a transition metal sulfide (A) with sulfur to produce a mixture of the transition metal sulfide (A) and sulfur, and subsequently combusting the mixture of the transition metal sulfide (A) and sulfur in an inert gas atmosphere to produce a sulfur-treated substance (B) of transition metal sulfide (A) that is almost a single phase as determined by XRD analysis and is represented by the formula (1) below:

M₍ₐ₎S_{(b)} (1)

(in which M is one or two or more of Fe, Ti, V, Cr, Mn, Co, Ni, Cu, and Zn); and

a second step of mixing the sulfur-treated substance (B) of transition metal sulfide (A) with lithium sulfide to produce a mixture of the sulfur-treated substance (B) of transition metal sulfide (A) and lithium sulfide, and subsequently combusting the mixture of the sulfur-treated substance (B) of transition metal sulfide (A) and lithium sulfide in an inert gas atmosphere to produce lithium transition metal sulfide represented by the formula (2) below:

LiₓMS_{y} (2)

(in which M is one or two or more of Fe, Ti, V, Cr, Mn, Co, Ni, Cu, and Zn. x is from 0.5 to 4.0, and y is from 0.5 to 4.0);

in which the formula (3) below is satisfied:

a/b<1/(y−(x/2)) (3)

### Advantageous Effects

According to the invention, it is possible to provide a process for producing single phase lithium iron sulfide (Li₂FeS₂) as determined by XRD analysis. In addition, according to the invention, it is possible to provide a process for producing single phase lithium transition metal sulfide as determined by XRD analysis.

### BRIEF DESCRIPTION OF DRAWINGS

FIG. 1 is an XRD chart of iron sulfide (b1) produced by the first step of Example 1.

FIG. 2 is an XRD chart of lithium iron sulfide produced by the second step of Example 1.

FIG. 3 is an XRD chart of iron sulfide (b2) produced by the first step of Example 2.

FIG. 4 is an XRD chart of lithium iron sulfide produced by the second step of Example 2.

FIG. 5 is an XRD chart of lithium iron sulfide produced by Comparative Example 1.

FIG. 6 is an XRD chart of iron sulfide (c1) used in Comparative Example 2.

FIG. 7 is an XRD chart of lithium iron sulfide produced by Comparative Example 2.

### BEST MODE FOR CARRYING OUT THE INVENTION

Hereinafter, the invention will be described on the basis of preferable embodiments.

The process for producing lithium iron sulfide of the invention including a first step of mixing an iron sulfide (a) with sulfur to produce a mixture of the iron sulfide (a) and sulfur, and subsequently combusting the mixture of the iron sulfide (a) and sulfur in an inert gas atmosphere to produce an iron sulfide (b) that has almost a single phase as determined by XRD analysis and has a molar ratio of the compositional ratio of the element iron to the element sulfur (Fe/S) of not less than 0.90 and less than 1.00; and

a second step of mixing the iron sulfide (b) with lithium sulfide to produce a mixture of the iron sulfide (b) and lithium sulfide, and subsequently combusting the mixture of the iron sulfide (b) and lithium sulfide in an inert gas atmosphere to produce lithium iron sulfide represented by the formula Li₂FeS₂.

The first step in the process for producing lithium iron sulfide of the invention is a process in which an iron sulfide (a) is mixed with sulfur to produce a mixture of the iron sulfide (a) and sulfur, and subsequently the mixture of the iron sulfide (a) and sulfur is combusted in an inert gas atmosphere to produce an iron sulfide (b).

The iron sulfide (a) in the first step is a substance sulfurated by sulfur, and thus has a low compositional ratio of the element sulfur compared to the iron sulfide (b) produced by performing the first step. In addition, the molar ratio of the content of the element iron to the content of the element sulfur of the iron sulfide (a) is appropriately selected according to the setting of the compositional ratio of the element iron to the element sulfur of the iron sulfide (b), but is preferably from 1.00 to 2.00, particularly preferably from 1.10 to 1.90, and, more preferably from 1.2 to 1.6. When the molar ratio (Fe/S) of the content of the element iron to the content of the element sulfur of the iron sulfide (a) is within the above range, it becomes easy to produce the iron sulfide (b). Meanwhile, in the invention, the molar ratio of the content of the element iron to the content of the element sulfur of the iron sulfide (a) is a value that can be obtained from the number of moles of the element iron/the number of moles of the element sulfur by calculating the number of moles of each element from the % by mass of the iron element and the sulfur element in the iron sulfide (a) obtained by ICP emission spectroscopy, chelatometry, precipitation gravimetry, or the like.

The iron sulfide (a) may be a commercially available product or a substance obtained by a well-known synthesis process. Examples of the synthesis process of the iron sulfide (a) include a process in which iron powder and sulfur are melted in a crucible. In the process, since part of sulfur, which is a raw material of synthesis, is volatilized, the molar ratio (Fe/S) of the content of the element iron to the content of the element sulfur of the resulting iron sulfide (a) becomes 1.00 or higher.

The average particle diameter of the iron sulfide (a) is preferably from 5 μm to 100 μm, and particularly preferably from 5 μm to 75 μm. When the average particle diameter of the iron sulfide (a) is within the above range, the reactivity between the iron sulfide (a) and sulfur increases in the first step. The content of coarse particles having a particle diameter exceeding 150 μm in the iron sulfide (a) is preferably 15% by mass or less, and particularly preferably 5% by mass or less. When the content of coarse particles in the iron sulfide (a) is within the above range, the reactivity between the iron sulfide (a) and sulfur increases in the first step. Meanwhile, in the invention, the content of coarse particles is a value obtained by the measurement of laser scattering particle size distribution, and the average particle diameter is an average particle diameter (D50) obtained by the measurement of laser scattering particle size diameter.

The sulfur in the first step is not particularly limited, and may be a commercially available product.

In addition, in the first step, firstly, the iron sulfide (a) and sulfur are mixed to produce a mixture of the iron sulfide (a) and sulfur, but sulfur is easily volatilized, and thus it is desirable to feed a larger amount of sulfur than the theoretical amount at which a desirable compositional ratio Fe/S of the iron sulfide (b) is produced. At this time, it is preferable to mix the iron sulfide (a) with sulfur such that the molar ratio (Fe/S) of the content of the element iron to the content of the element sulfur in the mixture of the iron sulfide (a) and sulfur becomes not less than 0.50 and less than 1.0, and it is particularly preferable to mix the iron sulfide (a) with sulfur such that the molar ratio becomes not less than 0.75 and 0.90 or less. Meanwhile, in the invention, the molar ratio (Fe/S) of the content of the element iron to the content of the element sulfur in the mixture of the iron sulfide (a) and sulfur is a value calculated from the number of moles of the element sulfur included in the iron sulfide (a) and the number of moles of the element sulfur included, both of which are obtained from the analysis results, such as ICP emission spectroscopy, chelatometry, precipitation gravimetry, or the like, and the number of moles of sulfur mixed into the iron sulfide (a).

In the first step, a method for mixing the iron sulfide (a) with sulfur is not particularly limited, and examples thereof include a mixing method using a coffee mill, a bead mill, a Henschel mixer, a cutter mixer, or the like.

In the first step, subsequently, the mixture of the iron sulfide (a) and sulfur is combusted in an inert gas atmosphere to produce the iron sulfide (b).

Examples of the inert gas in the first step include argon gas, helium gas, nitrogen gas, or the like. The inert gas preferably has a high purity to prevent incorporation of impurities into a product, and has a dew point of −50° C. or lower, and particularly preferably −60° C. or lower to avoid contact with moisture. A method for introducing the inert gas to a reaction system is not particularly limited as long as an inert gas atmosphere is formed in the reaction system, and examples thereof include a method in which the inert gas is purged, and a method in which a constant amount of inert gas is continuously introduced.

In the first step, the combustion temperature when combusting the mixture of the iron sulfide (a) and sulfur is preferably from 500° C. to 1200° C., and particularly preferably from 700° C. to 1000° C. When the combustion temperature when combusting the mixture of the iron sulfide (a) and sulfur in the first step is within the above range, it becomes easy to produce the iron sulfide (b). In addition, in the first step, the combustion time when combusting the mixture of the iron sulfide (a) and sulfur is preferably from 1 hour to 24 hours, and particularly preferably from 2 hours to 12 hours. When the combustion time of the mixture of the iron sulfide (a) and sulfur in the first step is within the above range, it becomes easy to produce the iron sulfide (b).

In addition, the iron sulfide (b) is produced by performing the first step, and the iron sulfide (b) has almost a single phase as determined by XRD analysis and a molar ratio of the compositional ratio (Fe/S) of the element iron to the element sulfur of not less than 0.90 and less than 1.00. For example, if a case in which the iron sulfide (b) is Fe_{0.96}S having almost a single phase is described, the iron sulfide (b) produces the peak pattern of Fe_{0.96}S in XRD analysis. At this time, in XRD analysis, the iron sulfide (b) preferably produces only the peak derived from Fe_{0.96}S, but Fe_{0.96}S having almost a single phase is sufficient and peaks derived from other substances may be produced without impairing the effects of the invention. When peaks derived from other substances are present, the iron sulfide (b) having almost a single phase may have a single phase ratio of 95% or higher, which is shown in the formula below:

Single phase ratio (%)=(P1/(P1+P2))×100

(in which P1 refers to the peak intensity of the peak having the highest peak intensity among the peaks derived from Fe_{0.96}S in the XRD chart of the iron sulfide (b), and P2 indicates the peak intensity of the peak having the highest peak intensity among the peaks other than the peaks derived from Fe_{0.96}S in the XRD chart of the iron sulfide (b)). That is, the iron sulfide (b) having almost a single phase as determined by XRD analysis in the invention indicates that the iron sulfide (b) is present as a single phase, or the single phase ratio defined in the above is 95% or higher.

Meanwhile, in the above, a case in which the iron sulfide (b) is Fe_{0.96}S having almost a single phase was described; however, the same description is applied to the other iron sulfide (b), for example, Fe_{0.94}S having almost a single phase. For example, if the iron sulfide (b) is Fe_{0.94}S having almost a single phase, the iron sulfide (b) produces the peak pattern of Fe_{0.94}S in XRD analysis. At this time, in XRD analysis, the iron sulfide (b) preferably produces only the peak derived from Fe_{0.94}S, but may be Fe_{0.94}S having almost a single phase and may produce peaks derived from other substances without impairing the effects of the invention. When peaks derived from other substances are present, the iron sulfide (b) having almost a single phase may have a single phase ratio of 95% or higher, which is shown in the formula below:

Single phase ratio (%)=(P1/(P1+P2))×100

(in which P1 refers to the peak intensity of the peak having the highest peak intensity among the peaks derived from Fe_{0.94}S in the XRD chart of the iron sulfide (b), and P2 indicates the peak intensity of the peak having the highest peak intensity among the peaks other than the peaks derived from Fe_{0.94}S in the XRD chart of the iron sulfide (b)).

The molar ratio of the compositional ratio (Fe/S) of the element iron to the element sulfur of the iron sulfide (b) is not less than 0.90 and less than 1.00, preferably from 0.91 to 0.99, particularly preferably from 0.93 to 0.97, further preferably from 0.94 to 0.96, and more preferably 0.94 or 0.96. Single phase lithium iron sulfide (Li₂FeS₂) is produced by setting the compositional ratio (Fe/S) of the iron sulfide (b), which is produced by performing the first step, in the above range and by performing the second step described below, but, when the compositional ratio of the iron sulfide (b) is smaller than 0.90, other than Li₂FeS₂ which is the object of the process, Li₃Fe₂S₄ or the like is liable to occur as a by-product, and, on the other hand, when the compositional ratio becomes 1.0 or higher, Li₂S or the like, which has occurred as a by-product or is not reacted, becomes liable to remain.

Examples of the iron sulfide (b) include Fe_{0.96}S having almost a single phase, Fe_{0.94}S having almost a single phase, Fe_{0.95}S having almost a single phase, Fe_{0.975}S having almost a single phase, Fe_{0.985}S having almost a single phase, Fe_{0.91}S having almost a single phase, Fe_{0.95}S_{1.05} having almost a single phase, Fe₉S₁₀ having almost a single phase, or the like. At this time, for example, the compositional ratio (Fe/S) of the element iron to the element sulfur of the iron sulfide (b) is 0.96/1=0.96 in the case of Fe_{0.96}S having almost a single phase, and 0.94/1=0.94 in the case of Fe_{0.94}S having almost a single phase.

When the iron sulfide (b) has almost a single phase as determined by XRD analysis and a compositional ratio (Fe/S) of the element iron to the element sulfur in the above range, lithium iron sulfide represented by single phase Li₂FeS₂ can be produced. Particularly, it is preferable that the iron sulfide (b) is one of iron sulfide having almost a single phase as determined by XRD analysis and a composition of Fe_{0.96}S and iron sulfide having almost a single phase as determined by XRD analysis and a composition of Fe_{0.94}S.

As such, the first step is a step in which the iron sulfide (a) is sulfurated so as to increase the compositional ratio of the element sulfur to the element iron and also to convert to single phase iron sulfide. In addition, when combusting the mixture of the iron sulfide (a) and sulfur in the first step, the amount of sulfur necessary for reaction with the iron sulfide (a) varies according to the setting of the compositional ratio of the element iron to the element sulfur of the iron sulfide (b) after combusting, the molar ratio used of the content of the element iron to the content of the element sulfur in the iron sulfide (a), or the like. In addition, sulfur includes sulfur that reacts with the iron sulfur (a) and sulfur that volatilizes so as to be removed from the reaction system. At this time, the amount of sulfur that volatilizes so as to be removed from the reaction system varies with the combustion temperature and the combustion time. Therefore, according to the compositional ratio of the element iron to the element sulfur of the iron sulfide (b) after the combustion, the molar ratio of the content of the element iron to the content of the element sulfur in the iron sulfide (a), the amount of sulfur mixed, the combustion temperature, the combustion time, or the like are appropriately selected to perform the first step. In summary, in the first step, by appropriately selecting the molar ratio of the content of the element iron to the content of the element sulfur in the iron sulfide (a), the amount of sulfur mixed, the combustion temperature, the combustion time, or the like, it is possible to produce the iron sulfide (b). Meanwhile, there are a variety of other preferable properties of the iron sulfide (b), and the average particle diameter of the iron sulfide (b) is preferably from 5 μm to 150 μm, and particularly preferably from 5 μm to 100 μm. When the average particle diameter of the iron sulfide (b) is within the above range, the reactivity between the iron sulfide (b) and lithium sulfide increases. In addition, the content of coarse particles having a particle diameter exceeding 100 μm in the iron sulfide (b) is preferably 15% by mass or less, and particularly preferably 5% by mass or less. When the content of coarse particles in the iron sulfide (b) is within the above range, the reactivity between the iron sulfide (b) and lithium sulfide in the second step increases. Meanwhile, in the invention, the content of coarse particles is a value obtained by the measurement of laser scattering particle size distribution, and the average particle diameter is an average particle diameter (D50) obtained by the measurement of laser scattering particle size distribution.

The second step in the process for producing lithium iron sulfide of the invention is a process in which the iron sulfide (b) and lithium sulfide are mixed to produce a mixture of the iron sulfide (b) and lithium sulfide, and, subsequently, the mixture of the iron sulfide (b) and lithium sulfide is combusted in an inert gas atmosphere to produce lithium iron sulfide represented by the formula Li₂FeS₂.

The lithium sulfide in the second step is not particularly limited, and may be a commercially available product. The molar ratio of the content of the element lithium to the content of the element sulfur in the lithium sulfide in the second step is from 1.90 to 2.10, and preferably from 1.95 to 2.05. When the molar ratio of the element lithium to the element sulfur in the lithium sulfide in the second step is within the above range, it becomes easy to produce single phase lithium sulfide (Li₂FeS₂). Meanwhile, the molar ratio of the element lithium to the element sulfur in the lithium sulfide in the second step is a value that can be obtained from the number of moles of the element lithium/the number of moles of the element sulfur by calculating the number of moles of each element from the % by mass of the lithium element and the sulfur element in the lithium sulfide obtained by ICP emission spectroscopy, chelatometry, precipitation gravimetry, or the like. In addition, the maximum particle diameter of the lithium sulfide in the second step is preferably 200 μm or less. In addition, the content of coarse particles having a particle diameter exceeding 200 μm in the lithium sulfide in the second step is preferably 10% by mass or less, and particularly preferably 5% by mass or less. When the content of coarse particles in the lithium sulfide is within the above range, the reactivity between the iron sulfide (b) and lithium sulfide in the second step increases. The average particle diameter of the lithium sulfide in the second step is preferably from 20 μm to 100 μm, and particularly preferably from 40 μm to 80 μm. When the average particle diameter of the lithium sulfide in the second step is within the above range, the reactivity between the iron sulfide (b) and lithium sulfide in the second step increases.

In the second step, firstly, the iron sulfide (b) and lithium sulfide are mixed to produce a mixture of the iron sulfide (b) and lithium sulfide.

In the second step, the ratio of the iron sulfide (b) and lithium sulfide mixed is preferably from 0.9 moles to 1.1 moles, and particularly preferably from 0.94 moles to 1.00 mole by the number of moles of lithium sulfide to 1 mole of the iron sulfide (b). When the ratio of the iron sulfide (b) and lithium sulfide mixed is within the above range, it becomes easy to produce single phase lithium iron sulfide (Li₂FeS₂).

In the second step, a mixing method for mixing the iron sulfide (b) and lithium sulfide is not particularly limited as long as the method can uniformly mix the iron sulfide (b) and lithium sulfide, but a mechanochemical treatment is preferable from the standpoint that it becomes easy to produce single phase lithium iron sulfide (Li₂FeS₂). Meanwhile, in the second step, the mixing is preferably performed in an inert gas atmosphere since lithium sulfide is not stable in the atmosphere.

The mixing method by a mechanochemical treatment in the second step refers to a method in which mixing is performed while mechanical energy, such as shearing force, impact force, or centrifugal force, is applied to the powder, which is the subject of mixing. Examples of devices which are used for the mixing method by a mechanochemical treatment in the second step include a crushing device, such as a bead mill, a planetary ball mill, an oscillating mill, or the like, that is, a device, in which granular media are present in powder, which is the subject of mixing, and are caused to flow at a high speed. In addition, by flowing the media at a high speed, mechanical energy is applied to powder, which is the subject of mixing, by the granular media.

In the mechanochemical treatment in the second step, the gravity acceleration applied to the mixture of the iron sulfide (b) and lithium sulfide is from 5 G to 40 G, and preferably from 8 G to 30 G. In addition, when using granular media, the particle diameter of the granular media is from 1 mm to 20 mm, and preferably from 5 mm to 15 mm, and the packing rate of the granular medium is from 10% to 50%, and preferably from 20% to 40%.

In the second step, subsequently, the mixture of the iron sulfide (b) and lithium sulfide is combusted in an inert gas atmosphere to produce lithium iron sulfide represented by the formula Li₂FeS₂.

Examples of the inert gas in the second step include argon gas, helium gas, nitrogen gas, or the like. The inert gas preferably has a high purity to prevent incorporation of impurities into a product, and has a dew point of −50° C. or lower, and particularly preferably −60° C. or lower to avoid contact with moisture. A method for introducing the inert gas to a reaction system is not particularly limited as long as an inert gas atmosphere is formed in the reaction system, and examples thereof include a method in which the inert gas is purged, and a method in which a constant amount of inert gas is continuously introduced.

In the second step, the combustion temperature when combusting the mixture of the iron sulfide (b) and lithium sulfide is preferably from 450° C. to 1500° C., and particularly preferably from 600° C. to 1200° C. When the combustion temperature when combusting the mixture of the iron sulfide (b) and lithium sulfide in the second step is within the above range, it becomes easy to produce single phase lithium iron sulfide (Li₂FeS₂). In addition, in the second step, the combustion time when combusting the mixture of the iron sulfide (b) and lithium sulfide is preferably from 1 hour to 24 hours, and particularly preferably from 1 hour to 18 hours. When the combustion time of the mixture of the iron sulfide (b) and lithium sulfide in the second step is within the above range, it becomes easy to produce lithium iron sulfide (Li₂FeS₂).

As such, lithium iron sulfide produced by performing the process for producing lithium iron sulfide of the invention is lithium iron sulfide represented by single phase Li₂FeS₂, for which no heterophase peak is observed in XRD analysis.

It is possible to crush and classify as necessary lithium iron sulfide that can be produced by performing the process for producing lithium iron sulfide of the invention. The crushing performed as necessary is not particularly limited, and includes well-known crushing methods using a mortar, a rotary mill, a coffee mill, or the like. In addition, the classifying performed as necessary is not particularly limited, and includes well-known methods using a sieve or the like. The crushing or classifying is preferably performed in an inert gas atmosphere or in a vacuum atmosphere from the standpoint that it is possible to avoid contact with moisture in the air. The average particle diameter of lithium iron sulfide which is crushed and classified as necessary is dependent on the purpose of use, but is preferably from 1 μm to 100 μm, and particularly preferably from 10 μm to 90 μm.

Since lithium iron sulfide that can be produced by performing the process for producing lithium iron sulfide of the invention is highly crystalline Li₂FeS₂ with no heterophase, lithium iron sulfide can be preferably used as a material for a positive electrode of a lithium ion secondary battery.

In iron sulfide, since a sulfur component is liable to volatilize when iron sulfide is produced, in general, metallic Fe or iron sulfide having a different phase is included, and the molar ratio of the content of the element iron to the content of the element sulfur is larger than 1. Therefore, by performing the first step of the process for producing lithium iron sulfide of the invention, metallic Fe or iron sulfide included in iron sulfide is sulfurated so as to produce iron sulfide having almost a single phase and a molar ratio of compositional ratio (Fe/S) of the element iron to the element sulfur of not less than 0.90 and less than 1.00, that is, the iron sulfide (b).

In addition, in the second step of the process for processing lithium iron sulfide of the invention, by using almost single phase iron sulfide that reacts with lithium sulfide as the iron sulfide (b), and by increasing the compositional ratio of sulfur in iron sulfide such that the molar ratio of the compositional ratio (Fe/S) of the element iron to the element sulfur becomes not less than 0.90 and less than 1.00, the amount of sulfur is made to be larger than the theoretical amount necessary to produce lithium iron sulfide (Li₂FeS₂), which is a target substance, and, consequently, single phase lithium iron sulfide (Li₂FeS₂) can be produced.

In the above, a case in which iron acts as the transition metal element was described; however, the same description is applied to a case in which a different lithium transition metal sulfide acts as the transition metal element. Therefore, it is possible to obtain transition metal sulfide having almost a single phase and a compositional ratio (a compositional ratio of the element transition metal/the element sulfur) at which the amount of sulfur becomes larger than the theoretical amount necessary to induce reaction with lithium sulfide so as to produce the lithium transition metal sulfide aimed for by sulfurating the transition metal sulfide with sulfur, and, subsequently, to obtain single phase lithium transition metal sulfide by inducing reaction between the resulting transition metal sulfide and lithium sulfide.

That is, the process for producing lithium transition metal sulfide including a first step of mixing a transition metal sulfide (A) with sulfur to produce a mixture of the transition metal sulfide (A) and sulfur, and subsequently combusting the mixture of the transition metal sulfide (A) and sulfur in an inert gas atmosphere to produce a sulfur-treated substance (B) of transition metal sulfide (A) that is almost a single phase as determined by XRD analysis and is represented by the formula (1) below:

M₍ₐ₎S_{(b)} (1)

(in which M is one or two or more of Fe, Ti, V, Cr, Mn, Co, Ni, Cu, and Zn); and

a second step of mixing the sulfur-treated substance (B) of transition metal sulfide (A) with lithium sulfide to produce a mixture of the sulfur-treated substance (B) of transition metal sulfide (A) and lithium sulfide, and subsequently combusting the mixture of the sulfur-treated substance (B) of transition metal sulfide (A) and lithium sulfide in an inert gas atmosphere to produce lithium transition metal sulfide represented by the formula (2) below:

LiₓMS_{y} 2)

(in which M is one or two or more of Fe, Ti, V, Cr, Mn, Co, Ni, Cu, and Zn. x is from 0.5 to 4.0, and y is from 0.5 to 4.0);

in which the formula (3) below is satisfied:

a/b<1/(y−(x/2)) (3)

The process for producing lithium transition metal sulfide of the invention is the same as the process for producing lithium iron sulfide of the invention except that the transition metal element is different, and the valence of the transition metal dependent on the kind of transition metal elements for the process and the compositional ratio of the element transition metal to the element sulfur are different.

In the above formula (1), a>0, and b>0.

In the above formula (2), x is from 0.5 to 4.0, and preferably from 1.0 to 3.0, and y is from 0.5 to 4.0, and preferably from 1.0 to 3.0.

Here, in the process for producing lithium transition metal sulfide of the invention, the formula (3) indicates that the compositional ratio of the element sulfur to the element transition metal in the transition metal sulfide which is made to react with lithium sulfide is made larger than the theoretical amount of sulfur necessary to produce lithium transition metal sulfide, which is the target substance, by inducing reaction with lithium sulfide.

### EXAMPLES

Hereinafter, the invention will be described in detail with examples, but the invention is not limited to the examples.

(1) ICP Emission Spectroscopy

Measurement was performed according to ICP emission spectroscopy using an ICP emission spectroscopy apparatus (Liberty Series II, produced by Varian), and the % by masses of each of the elements were obtained based on the measurement so as to calculate the molar ratios.

(2) Maximum Particle Diameter, Average Particle Diameter and Content of Coarse Particles

The maximum particle diameter, the average particle diameter and the contents of coarse particles were obtained by the measurement method of laser scattering particle size distribution using a particle size distribution measuring apparatus (MICROTRAC X-100, produced by Nikkiso Co., Ltd.).

(3) XRD Analysis

XRD analysis was performed using an XRD apparatus (D8 ADVANCE, produced by Bruker AXS).

### Example 1

(First Step)

22 g of iron sulfide (al) (produced by Hosoi Chemical Industry Co., Ltd.), for which the molar ratio (Fe/S) of the content of the element iron to the content of the element sulfur by ICP emission spectroscopy was 1.53, the maximum particle diameter was 150 μm (the content of coarse particles exceeding 150 μm was 0% by mass), and the average particle diameter (D50) was 10 μm, and 3.76 g of sulfur (produced by Kanto chemical Co., Inc.) were mixed with a coffee mill. At this time, the Fe/S molar ratio in the mixture was 0.94 (calculated from the results of the ICP emission spectroscopy and the amount of sulfur added and mixed).

Subsequently, the mixture was fed into an alumina container, which was set in a quartz horizontal tube-shaped furnace, and was combusted at 950° C. for 3 hours in a nitrogen stream with a flux of 0.1 L/minute from the ventilation hole of the tube-shaped furnace. After the combustion, the mixture was cooled to room temperature so as to produce iron sulfide (b1) which is a combusted substance. The resulting iron sulfide (b1) was subjected to XRD analysis, and the XRD pattern thereof is shown in FIG. 1. From the resulting XRD pattern, it was confirmed that the iron sulfide (b1) was Fe_{0.96}S single phase. Meanwhile, in the XRD pattern shown in FIG. 1, no peak derived from substances other than Fe_{0.96}S was observed. Meanwhile, the average particle diameter of the iron sulfide (b1) was 50 μm, and the content of coarse particles exceeding 100 μm was 2% by mass.

(Second Step)

3.66 g of the iron sulfide (b1) produced in the above manner and 1.84 g of lithium sulfide (produced by Nippon Chemical Industrial Co., Ltd.), for which the molar ratio of Li/S by ICP emission spectroscopy was 2.00, the average particle diameter was 70 μm, and the content of coarse particles exceeding 200 μm was 0% by mass, were fed into a planetary ball mill (P-7, produced by Fritsch Japan Co. Ltd.), and a mechanochemical treatment was performed for 1 hour in an argon gas atmosphere under the following conditions to produce a mixture.

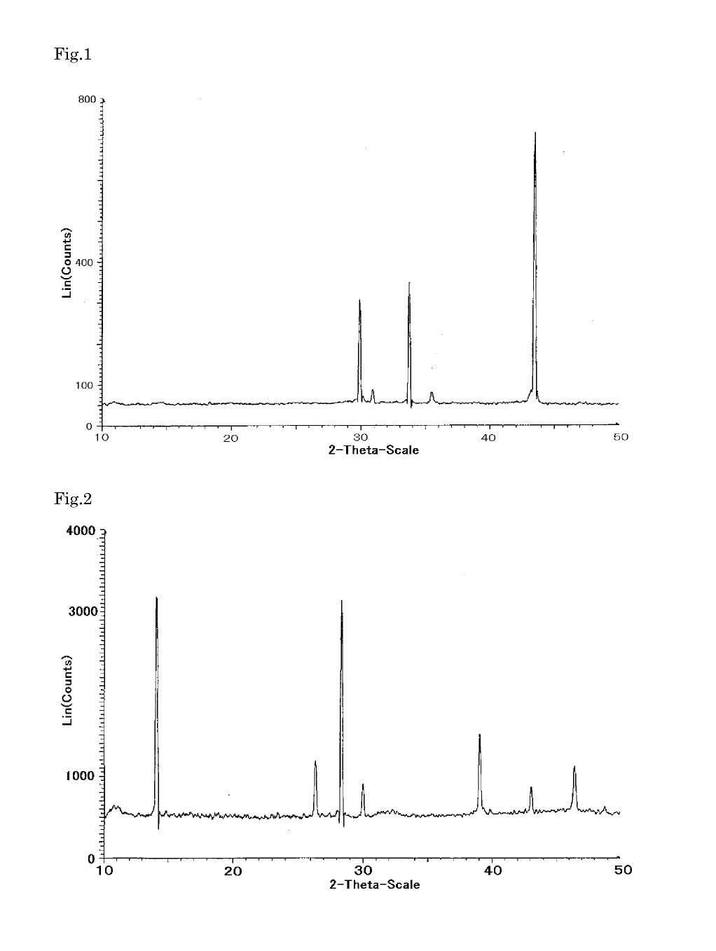

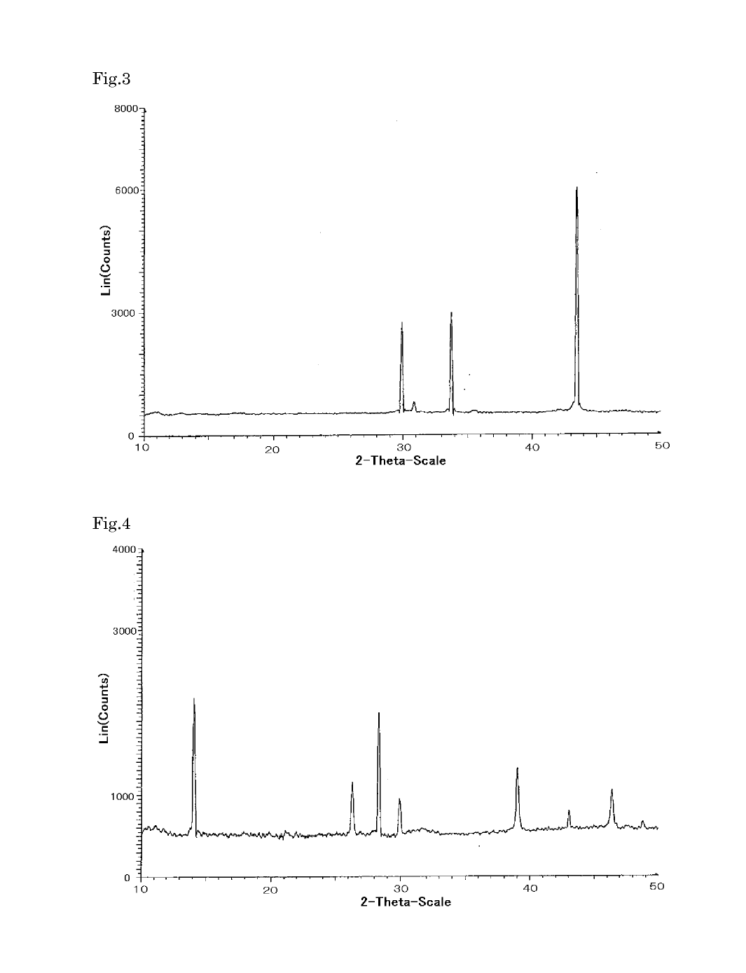

Subsequently, the mixture was fed into an alumina container, which was set in a quartz horizontal tube-shaped furnace, and was combusted at 950° C. for 12 hours in a nitrogen stream with a flux of 0.1 L/minute from the ventilation hole of the tube-shaped furnace. After the combustion, the mixture was cooled to room temperature so as to produce lithium iron sulfide which is a combusted substance. The resulting lithium iron sulfide was subjected to XRD analysis, and the XRD pattern thereof is shown in FIG. 2. From the resulting XRD pattern, it was confirmed that the lithium iron sulfide was Li₂FeS₂ single phase. Meanwhile, in the XRD pattern shown in FIG. 2, no peak derived from substances other than Li₂FeS₂ was observed. In addition, ICP emission spectroscopy produced the results of 10.5% by mass of Li, 41.7% by mass of Fe, and 47.8% by mass of S. By calculating molar ratios from the results, the Fe/Li molar ratio was 0.50, and the Fe/S molar ratio was 0.50. Even from the results, it was confirmed that the lithium iron sulfide was Li₂FeS₂ single phase. The resulting lithium iron sulfide was crushed with a mortar and was classified with a sieve having a mesh size of 100 μm so as to produce Li₂FeS₂ with an average particle diameter of 50 μm.

<Conditions for Mechanochemical Treatment>

Granular medium: average particle diameter of 10 mm, and packing rate of 30%

Revolutions per minute: 400 rpm

Gravity acceleration: 10.9 G

### Example 2

(First Step)

Iron sulfide (b2), which is a combusted substance, was produced in the same manner as Example 1 except that 3.76 g of sulfur (produced by Kanto chemical Co., Inc.) was replaced with 4.46 g of sulfur (produced by Kanto chemical Co., Inc.) so as to set a Fe/S molar ratio in the mixture to 0.87 (calculated from the results of the ICP emission spectroscopy and the amount of sulfur mixed). The resulting iron sulfide (b2) was subjected to XRD analysis, and the XRD pattern thereof is shown in FIG. 3. From the resulting XRD pattern, it was confirmed that the iron sulfide (b2) was Fe_{0.94}S single phase. Meanwhile, in the XRD pattern shown in FIG. 3, no peak derived from substances other than Fe_{0.94}S was observed. Meanwhile, the average particle diameter of the iron sulfide (b2) was 50 μm, and the content of coarse particles exceeding 100 μm was 1% by mass.

(Second Step)

Lithium iron sulfide, which is a combusted substance, was produced in the same manner as Example 1 except that 3.66 g of the iron sulfide (b1) was replaced with 4.46 g of the iron sulfide (b2). The resulting lithium iron sulfide was subjected to XRD analysis, and the XRD pattern thereof is shown in FIG. 4. From the resulting XRD pattern, it was confirmed that the lithium iron sulfide was Li₂FeS₂ single phase. Meanwhile, in the XRD pattern shown in FIG. 4, no peak derived from substances other than Li₂FeS₂ was observed. In addition, ICP emission spectroscopy produced the results of 10.4% by mass of Li, 41.8% by mass of Fe, and 47.8% by mass of S. By calculating molar ratios from the results, the Fe/Li molar ratio was 0.50, and the Fe/S molar ratio was 0.50. Even from the results, it was confirmed that the lithium iron sulfide was Li₂FeS₂ single phase. The resulting lithium iron sulfide was crushed with a mortar and was classified with a sieve having a mesh size of 100 μm so as to produce Li₂FeS₂ with an average particle diameter of 50 μm.

### Comparative Example 1

5.27 g of the iron sulfide (produced by Soekawa Chemical Co., Ltd.), for which the molar ratio (Fe/S) of the content of the element iron to the content of the element sulfur by ICP emission spectroscopy was 1.43, the maximum particle diameter was 320 μm (the content of coarse particles exceeding 150 μm was 8% by mass), and the average particle diameter (D50) was 60 μm, and 2.76 g of lithium sulfide (produced by Nippon Chemical Industrial Co., Ltd.), for which the molar ratio of Li/S by ICP emission spectroscopy was 2.00, the average particle diameter was 70 μm, and the content of coarse particles exceeding 200 μm was 0% by mass, were fed into a planetary ball mill (P-7, produced by Fritsch Japan Co., Ltd.), and a mechanochemical treatment was performed for 1 hour in an argon gas atmosphere under the same conditions as Example 1 to produce a mixture.

Subsequently, the mixture was fed into an alumina container, which was set in a quartz horizontal tube-shaped furnace, and was combusted at 950° C. for 12 hours in a nitrogen stream with a flux of 0.1 L/minute from the ventilation hole of the tube-shaped furnace. After the combustion, the mixture was cooled to room temperature so as to produce lithium iron sulfide which is a combusted substance. The resulting lithium iron sulfide was subjected to XRD analysis, and the XRD pattern thereof is shown in FIG. 5. From the resulting XRD pattern, peaks of Li₃Fe₂S₄ other than Li₂FeS₂ were confirmed. In addition, ICP emission spectroscopy produced the results of 10.4% by mass of Li, 40.4% by mass of Fe, and 49.2% by mass of S. By calculating molar ratios from the results, Fe/Li molar ratio was 0.48, and Fe/S molar ratio was 0.47. Even from the results, it was confirmed that substances other than Li₂FeS₂ were present.

### Comparative Example 2

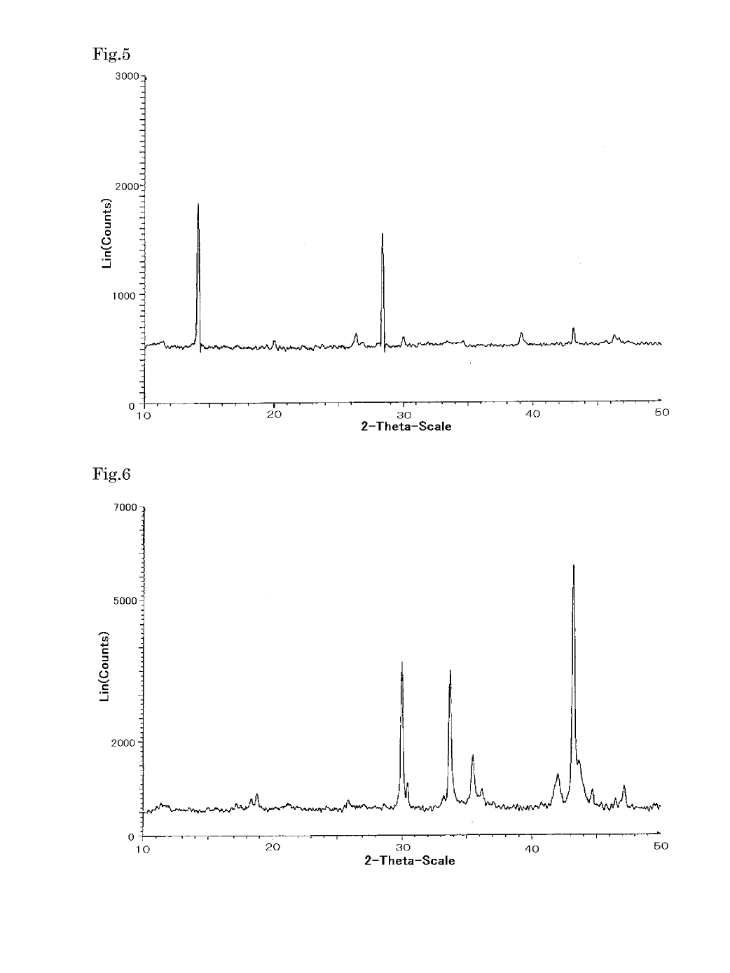

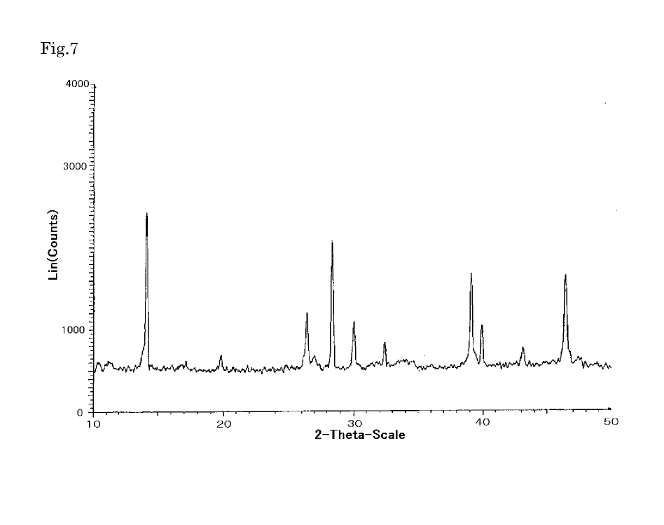

5.27 g of iron sulfide (c1) (produced by Soekawa Chemical Co., Ltd.), for which the molar ratio (Fe/S) of the content of the element iron to the content of the element sulfur by ICP emission spectroscopy was 0.97, the maximum particle diameter was 200 μm (the content of coarse particles exceeding 150 μm was 1% by mass), and the average particle diameter (D50) was 10 μm, and 2.76 g of lithium sulfide (produced by Nippon Chemical Industrial Co., Ltd.), for which the molar ratio of Li/S by ICP emission spectroscopy was 2.00, the average particle diameter was 70 μm, and the content of coarse particles exceeding 200 μm was 0% by mass, were fed into a planetary ball mill (P-7, produced by Fritsch Japan Co., Ltd.), and a mechanochemical treatment was performed for 1 hour in an argon gas atmosphere under the same conditions as Example 1 to produce a mixture. Here, the results of XRD analysis of the iron sulfide (c1) used herein is shown in FIG. 6, and it was confirmed that the iron sulfide (C1) included Fe heterophases from the XRD pattern.

Subsequently, the mixture was fed into an alumina container, which was set in a quartz horizontal tube-shaped furnace, and was combusted at 950° C. for 12 hours in a nitrogen stream with a flux of 0.1 L/minute from the ventilation hole of the tube-shaped furnace. After the combustion, the mixture was cooled to room temperature so as to produce lithium iron sulfide which is a combusted substance. The resulting lithium iron sulfide was subjected to XRD analysis, and the XRD pattern thereof is shown in FIG. 7. From the resulting XRD pattern, peaks of Li₂S other than Li₂FeS₂ were observed. In addition, ICP emission spectroscopy produced the results of 11.1% by mass of Li, 45.1% by mass of Fe, and 43.8% by mass of S. By calculating molar ratios from the results, the Fe/Li molar ratio was 0.51, and the Fe/S molar ratio was 0.59. Even from the results, it was confirmed that substances other than Li₂FeS₂ were present.

### INDUSTRIAL APPLICABILITY

According to the process for producing lithium iron sulfide of the invention, since highly crystalline Li₂FeS₂ can be produced, it is possible to produce, at a low cost, Li₂FeS₂ that is preferably used as, for example, a material for the positive electrode of a lithium ion secondary battery.

1. A process for producing lithium iron sulfide, comprising:
a first step of mixing an iron sulfide (a) with sulfur to produce a mixture of the iron sulfide (a) and sulfur, and subsequently combusting the mixture of the iron sulfide (a) and sulfur in an inert gas atmosphere to produce an iron sulfide (b) that has almost a single phase as determined by X-ray diffraction analysis and has a molar ratio of the compositional ratio of the element iron to the element sulfur (Fe/S) of not less than 0.90 and less than 1.00; and
a second step of mixing the iron sulfide (b) with lithium sulfide to produce a mixture of the iron sulfide (b) and lithium sulfide, and subsequently combusting the mixture of the iron sulfide (b) and lithium sulfide in an inert gas atmosphere to produce lithium iron sulfide represented by the formula Li₂FeS₂.

2. The process for producing lithium iron sulfide according to claim 1,
wherein the molar ratio of the content of the element iron to the content of the element sulfur of the iron sulfide (a) (Fe/S) is from 1.00 to 2.00.

3. The process for producing lithium iron sulfide according to claim 1,
wherein, in the first step, the iron sulfide (a) and sulfur are mixed such that the molar ratio (Fe/S) of the content of the element iron to the content of the element sulfur in the mixture of the iron sulfide (a) and sulfur becomes not less than 0.50 and less than 1.0.

4. The process for producing lithium iron sulfide according to claim 1,
wherein, in the first step, the mixture of the iron sulfide (a) and sulfur is combusted at from 500° C. to 1200° C.

5. The process for producing lithium iron sulfide according to claim 1,
wherein the iron sulfide (b) has almost a single phase as determined by X-ray diffraction analysis and a composition of Fe_{0.96}S.

6. The process for producing lithium iron sulfide according to claim 1,
wherein the iron sulfide (b) has almost a single phase as determined by X-ray diffraction analysis and a composition of Fe_{0.94}S.

7. The process for producing lithium iron sulfide according to claim 1,
wherein, in the second step, the iron sulfide (b) and lithium sulfide are mixed by a mechanochemical treatment.

8. A process for producing lithium transition metal sulfide, comprising:
a first step of mixing a transition metal sulfide (A) with sulfur to produce a mixture of the transition metal sulfide (A) and sulfur, and subsequently combusting the mixture of the transition metal sulfide (A) and sulfur in an inert gas atmosphere to produce a sulfur-treated substance (B) of transition metal sulfide (A) that is almost a single phase as determined by X-ray diffraction analysis and is represented by the formula (1) below:
M₍ₐ₎S_{(b)} (1)
(in which M is one or two or more of Fe, Ti, V, Cr, Mn, Co, Ni, Cu, and Zn); and
a second step of mixing the sulfur-treated substance (B) of transition metal sulfide (A) with lithium sulfide to produce a mixture of the sulfur-treated substance (B) of transition metal sulfide (A) and lithium sulfide, and subsequently combusting the mixture of the sulfur-treated substance (B) of transition metal sulfide (A) and lithium sulfide in an inert gas atmosphere to produce lithium transition metal sulfide represented by the formula (2) below:
LiₓMS_{y} (2)
(in which M is one or two or more of Fe, Ti, V, Cr, Mn, Co, Ni, Cu, and Zn. x is from 0.5 to 4.0, and y is from 0.5 to 4.0);
wherein the formula (3) below is satisfied:
a/b<1/(y−(x/2)) (3)
